(19) United States
(12) Patent Application Publication
(10) Pub. No.: US 2015/0054310 A1
(43) Pub. Date: Feb. 26, 2015

(54) VEHICLE BODY STRUCTURE

(71) Applicant: Nobuyuki Torii, Nagoya-shi (JP)

(72) Inventor: Nobuyuki Torii, Nagoya-shi (JP)

(73) Assignee: TOYOTA JIDOSHA KABUSHIKI KAISHA, Toyota-shi, Aichi-ken (JP)

(21) Appl. No.: 14/387,360

(22) PCT Filed: Mar. 23, 2012
(86) PCT No.: PCT/JP2012/057600

§ 371 Date: Sep. 23, 2014

(51) Int. Cl. B62D 25/06

(52) U.S. Cl. CPC B62D 25/06
USPC 296/187.12

(57) ABSTRACT

A vehicle body structure that can enhance the performance of absorbing an impact from a lateral face of a vehicle, equipped with a roof side rail that is arranged at a lateral position on an upper side of a vehicle and extends in a longitudinal direction of the vehicle, and a center pillar that extends in a vertical direction of the vehicle and has an upper end portion that is joined to a non-end position of the roof side rail in an extension direction. A deformation guide portion that provides guidance such that the roof side rail is deformed along a direction of a virtual axis that extends in a direction inclined with respect to a direction perpendicular to the extension direction of the roof side rail in a lateral view when a load is input from a lateral portion of the vehicle is formed on the roof side rail.

### TECHNICAL FIELD

The invention relates to a vehicle body structure, and more particularly, to an upper structure of a vehicle body with a roof side rail that can favorably absorb a collision load that is applied to a center pillar at the time of a lateral collision of a vehicle.

### BACKGROUND ART

A front pillar, a center pillar, a rear pillar, a roof side rail, a rocker and the like are employed as skeleton component members that constitute a skeleton structure of a vehicle. Among these skeleton component members, the front pillar is provided at a front portion of the vehicle. The center pillar is provided at a central portion in a longitudinal direction of the vehicle. The rear pillar is provided at a rear portion of the vehicle. Besides, the roof side rail is provided at an upper portion of the vehicle. Then, the rocker is provided at a lower portion of the vehicle.

As such skeleton component members, there is known a vehicle skeleton structure that efficiently absorbs an impact by controlling the modes of deformation of skeleton component members caused by a lateral collision or the like. For example, a vehicle body lateral structure is described in Patent Document 1. This vehicle body lateral structure is equipped with side sills that are extended in a longitudinal direction at lower-right and lower-left portions of a vehicle body respectively, side roof rails that are extended in the longitudinal direction at upper-right and upper-left portions of the vehicle body respectively, and center pillars that are extended in a vertical direction at right and left lateral portions of the vehicle body respectively and have upper and lower ends coupled to the side roof rails and the side sills respectively. Sill reinforcement portions are provided from lower ends of the center pillars along the side sills, at an equal distance in the longitudinal direction of the vehicle body, respectively. In this vehicle body lateral structure, the torsional forces applied to the center pillars by a pair of the sill reinforcement portions are counterbalanced, so the center pillars are restrained from being deformed to be twisted.

### RELATED ART DOCUMENT

### Patent Document

Patent Document 1: Japanese Patent Application Publication No. 2001-163263 (JP-2001-163263 A)

### SUMMARY OF THE INVENTION

### Problem to Be Solved by the Invention

In the vehicle body lateral structure described in Patent Document 1, when a collision load is input, to one of the center pillars from one lateral face of the vehicle, an upper end of that center pillar is pulled in downward, so a roof side rail is twisted. The twist of this roof side rail occurs from a position corresponding to a small strength. At this time, with the vehicle body lateral structure described in Patent Document 1, the roof side rail is small in cross-section, and is twisted at a position corresponding to a small yield strength. Therefore, the collision load input to the center pillar cannot be efficiently absorbed by the roof side rail in some cases.

It is thus an object of the invention to provide a vehicle body structure that can enhance the performance against a collision from a lateral face of a vehicle.

### Means for Solving the Problem

A vehicle body structure according to the invention is equipped with a roof side rail that is arranged at a lateral position on an upper side of a vehicle and extends in a longitudinal direction of the vehicle, and a center pillar that extends in a vertical direction of the vehicle and has an upper end portion that is joined to a non-end position of the roof side rail in an extension direction thereof. A deformation guide portion that provides guidance such that the roof side rail is deformed along a direction of a virtual axis that extends in a direction inclined with respect to a direction perpendicular to the extension direction of the roof side rail in a lateral view when a load is input from a lateral portion of the vehicle is formed on the roof side rail.

In the vehicle body structure according to the invention, when a load is input from the lateral portion of the vehicle, the roof side rail is guided by the deformation guide portion in such a manner as to be deformed along the direction of the virtual axis that extends in the direction inclined with respect to the direction perpendicular to the extension direction of the roof side rail in a lateral view. The cross-section of the roof side rail along the direction of this virtual axis is larger in area than the cross-section of the roof side rail along the perpendicular direction. Accordingly, by providing guidance such that the roof side rail is deformed along the direction of the virtual axis, the point from which the roof side rail is twisted at the time of a lateral collision can be set to a position corresponding to a large cross-section and a large yield strength. Therefore, the torsional reactive force that is generated in the roof side rail can be increased. In consequence, according to this vehicle body structure, the performance against a collision from the lateral face of the vehicle can be enhanced.

Besides, the roof side rail may be configured by combining an outer roof side rail, which is disposed on an outer side of the vehicle, and an inner roof side rail, which is disposed on an inner side of the vehicle, with each other in a face-to-face manner, and the deformation guide portion may be constituted by a hole that is formed through the outer roof side rail on the virtual axis.

According to this configuration, when a collision load is input from the lateral face of the vehicle, stress concentrates on the hole formed through the outer roof side rail on the virtual axis, so initial deformation toward the direction of the virtual axis can be induced. Therefore, guidance can be provided such that the roof side rail is deformed along the direction of the virtual axis.

Besides, the hole may be rectangular, and one diagonal line of the hole may extend along the direction of the virtual axis. According to this configuration, stress concentrates on the diagonal line of the rectangular hole with a large opening width. Therefore, guidance can be provided such that the roof side rail is deformed along the direction of the virtual axis.

Besides, a notch portion that extends along the direction of the virtual axis may be formed at an edge of the outer roof side rail. According to this configuration, stress concentrates at the notch portion. Therefore, a trigger for deformation of the roof side rail in the direction of the virtual axis can be created. If the hole is enlarged, the strength of the roof side rail decreases. However, according to this configuration, guidance can be provided such that the roof side rail is deformed along the direction of the virtual axis, without enlarging the hole.

Besides, a front pillar that extends in the vertical direction of the vehicle and is joined to a front end portion of the roof side rail may further be provided. The deformation guide portion may be provided on a front pillar side with respect to an intermediate position between the center pillar and the front pillar. The direction of the virtual axis may be a direction that is inclined upward toward a front side of the vehicle with respect to the direction perpendicular to the extension direction of the roof side rail, in a lateral view.

According to this configuration, the roof side rail is twisted from the deformation guide portion that is provided on the front pillar side with respect to the intermediate position between the center pillar and the front pillar. Therefore, the roof side rail is twisted from the position that is spaced apart from a joint spot with the center pillar on the roof side rail. The joint spot with the center pillar on the roof side rail is prevented from shifting downward. In consequence, according to this vehicle body structure, the center pillar can be restrained from being deformed, and the performance against a collision from the lateral face of the vehicle can be enhanced.

Besides, a rear pillar that extends in the vertical direction of the vehicle and is joined to a rear end portion of the roof side nil may further be provided. The deformation guide portion may be provided on a rear pillar side with respect to the intermediate position between the center pillar and the rear pillar. The direction of the virtual axis may be a direction that is inclined upward toward a rear side of the vehicle with respect to the direction perpendicular to the extension direction of the roof side rail, in a lateral view.

According to this configuration, the roof side rail is twisted from the deformation guide portion that is provided on the rear pillar side with respect to the intermediate position between the center pillar and the rear pillar. Therefore, the roof side rail is twisted from the position that is spaced apart from the joint spot with the center pillar on the roof side rail. The joint spot with the center pillar on the roof side rail is prevented from shifting downward. In consequence, according to this vehicle body structure, the center pillar can be restrained from being deformed, and the performance against a collision from the lateral face of the vehicle can be enhanced.

### Effect of the Invention

According to the invention, the performance against a collision from a lateral face of a vehicle can be enhanced.

### BRIEF DESCRIPTION OF THE DRAWINGS

FIG. 1 is a perspective view of a vehicle body structure according to the present embodiment of the invention.

FIG. 2 is a cross-sectional view of a roof side rail.

FIG. 3 is an enlarged view of a rear end portion of the roof side rail as viewed from behind a vehicle.

### MODE FOR CARRYING OUT THE INVENTION

Hereinafter, a preferred embodiment of the invention will be described in detail with reference to the accompanying drawings. Incidentally, like components are denoted by like reference symbols respectively in describing the drawings, and redundant description thereof will be omitted. Besides, for the convenience of diagrammatic representation, the dimensional ratios in the drawings do not necessarily coincide with those described.

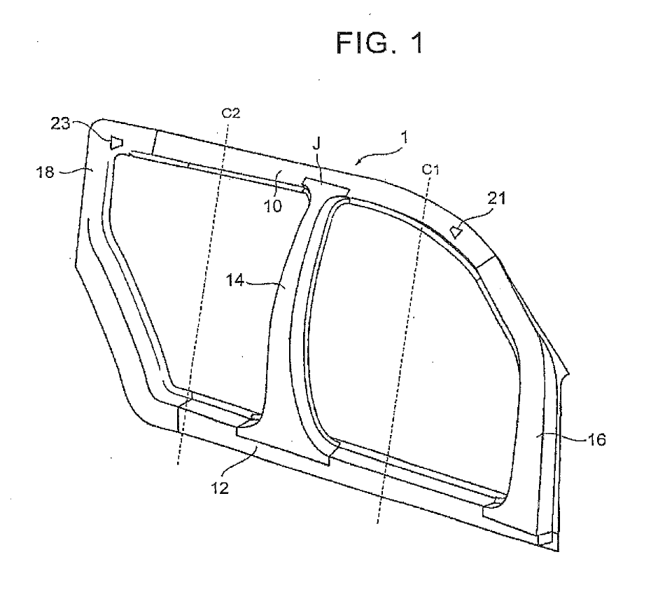

FIG. 1 is a perspective view of a vehicle body structure according to the embodiment of the invention. As shown in FIG. 1, a vehicle body structure 1 according to the present embodiment of the invention is equipped, as a side member structure, with a roof side rail 10, a rocker 12, a center pillar 14, a front pillar 16, and a rear pillar 18, which are skeleton component members.

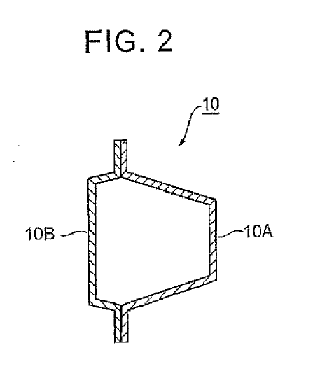

The roof side rail 10 and the rocker 12 are members that are arranged at a lateral position of a vehicle and extend in a longitudinal direction of the vehicle. Together with the center pillar 14, the front pillar 16, and the rear pillar 18, the roof side rail 10 and the rocker 12 function as members that absorb energy at the time of a lateral collision. The roof side rail 10 is arranged on an upper side of the vehicle, and the rocker 12 is arranged on a lower side of the vehicle. As shown in FIG. 2, the roof side rail 10 is configured by combining an outer roof side rail 10A and an inner roof side rail 10B with each other in a face-to-face manner. The rocker 12 is configured by combining an outer rocker (not shown) and an inner rocker (not shown) with each other in a face-to-face manner.

The center pillar 14, the front pillar 16, and the rear pillar 18 are members that extend in a vertical direction of the vehicle, and function as members that absorb energy at the time of a lateral collision. The center pillar 14 is arranged substantially at a central portion in the longitudinal direction of the vehicle. An upper end portion of the center pillar 14 is joined at a joint spot J as a non-end position in an extension direction of the roof side rail 10. A lower end portion of the center pillar 14 is joined to a non-end position in an extension direction of the rocker 12. The center pillar 14 is configured by combining an outer center pillar (not shown) and an inner center pillar (not shown) with each other in a face-to-face manner.

The front pillar 16 is arranged at a front portion of the vehicle that is equipped with the vehicle body structure 1. An upper end portion of the front pillar 16 is joined to a front end portion of the roof side rail 10, and a lower end portion of the front pillar 16 is joined to a front end portion of the rocker 12. The front pillar 16 is configured by combining an outer front pillar (not shown) and an inner front pillar (not shown) with each other in a face-to-face manner.

The rear pillar 18 is arranged at a rear portion of the vehicle that is equipped with the vehicle body structure 1. An upper end portion of the rear pillar 18 is joined to a rear end portion of the roof side rail 10, and a lower end portion of the rear pillar 18 is joined to a rear end portion of the rocker 12. The rear pillar 18 is configured by combining an outer rear pillar (not shown) and an inner rear pillar (not shown) with each other in a face-to-face manner.

Deformation guide portions 21 and 23 are formed at front and rear portions of the roof side rail 10, at positions deviant from the joint spot J with the center pillar 14, respectively. The deformation guide portions 21 and 23 function in such a manner as to provide guidance such that the roof side rail 10 is deformed in the direction of a virtual axis that extends in a direction inclined rearward in terms of the vehicle with respect to a direction perpendicular to the roof side rail 10 when a load is input from a lateral portion of the vehicle.

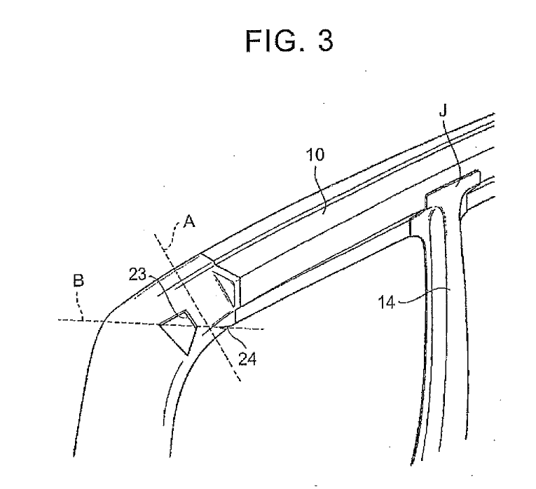

FIG. 3 is an enlarged view of a rear end portion of the roof side rail 10 as viewed from behind the vehicle. In the present embodiment of the invention, as shown in FIG. 3, the deformation guide portion 23 is provided on a rear portion side of the roof side rail 10. This position is located on the rear pillar 18 side with respect to an intermediate position C2 on the roof side rail 10 between the center pillar 14 and the rear pillar 18. In FIG. 3, a virtual axis A is a direction perpendicular to the extension direction of the roof side rail 10 in a lateral view, and a virtual axis B (a virtual axis) is a direction inclined rearward in terms of the vehicle with respect to the virtual axis A. In FIG. 3, the virtual axis B is inclined upward toward a rear side of the vehicle with respect to the virtual axis A.

In the present embodiment of the invention, as shown in FIG. 3, a rectangular hole is formed through the outer roof side rail 10A. This hole constitutes the deformation guide portion 23. One diagonal line of the rectangle of the deformation guide portion 23 is formed in such a manner as to extend along the virtual axis B. If the deformation guide portion 23 is thus formed, stress concentrates in the direction of the virtual axis B of the deformation guide portion 23 with a large opening width when a collision load is input from the lateral face of the vehicle. Therefore, when a collision load is input from the lateral face of the vehicle, the roof side rail 10 is guided in such a manner as to be deformed along the virtual axis B by the deformation guide portion 23.

In a lateral view, the cross-section of the roof side rail 10 along the direction of the virtual axis B is larger in area than the cross-section of the roof side rail 10 along the direction of the virtual axis A. Accordingly, in the case where the roof side rail 10 is deformed along the direction of the virtual axis B, the reactive force generated in the roof side rail 10 is larger than in the case where the roof side rail 10 is deformed along the direction of the virtual axis B.

Besides, in the present embodiment of the invention, a notch portion 24 is formed at a lower edge of the outer roof side rail 10A. The notch portion 24 is a groove that is formed in the outer roof side rail 10A, and extends from the lower edge of the outer roof side rail 10A toward the deformation guide portion 23 along the direction of the virtual axis B. The notch portion 24 has a function of inducing deformation of the roof side rail 10 along the direction of the virtual axis B when a collision load is input from the lateral face of the vehicle. That is, when a collision load is input from the lateral face of the vehicle, stress concentrates at the notch portion 24 and triggers deformation of the roof side rail 10 in the direction of the virtual axis B.

The deformation guide portion 21 is provided on the front pillar 16 side with respect to an intermediate position C1 on the roof side rail 10 between the center pillar 14 and the front pillar 16. In this case, the deformation guide portion 21 provides guidance such that the roof side rail 10 is deformed along a direction that is inclined upward toward a front side of the vehicle with respect to the direction perpendicular to the extension direction of the roof side rail 10 in a lateral view. The deformation guide portion 21 that is formed at a front portion of the roof side rail 10 is configured symmetrically to the deformation guide portion 23 with respect to the center pillar 14. Therefore, detailed description of the deformation guide portion 21 will be omitted.

Next, the operation and effect of the vehicle body structure 1 according to the present embodiment of the invention will be described. A twist that occurs in the roof side rail 10 is likely to occur from a position corresponding to a small yield strength, such as a position corresponding to a small cross-section or the like. However, if a twist occurs from such a position corresponding to a small yield strength, a sufficient torsion reactive force cannot be applied. For example, in the case where the roof side rail 10 is twisted in the cross-section along the direction of the virtual axis A in a lateral view, a sufficient torsion reactive force cannot be applied thereto, and the amount of inward deformation of the center pillar 14 in the vehicle width direction increases.

In this respect, with the vehicle body structure 1 according to the present embodiment of the invention, the deformation guide portions 21 and 23 are provided, so a twist occurs from the cross-section along the direction of the virtual axis B, which is larger in area than the cross-section along the direction of the virtual axis A, in a lateral view. Therefore, the torsion reactive force can be enhanced.

Besides, in the case where a load is input to the vehicle laterally, the center pillar 14 absorbs part of the input load while being deformed inward in the vehicle width direction, during the initial stage of a collision. In this case, an inward load in the vehicle width direction is input to the roof side rail 10, and a downward load that is caused by pulling the center pillar 14 downward is input to the roof side rail 10.

The roof side rail 10 is pulled in downward due to this downward load, so a twist occurs in the roof side rail 10 of the vehicle body structure 1. In this case, if the position where the center pillar 14 is twisted is close to the joint spot J, the amount of descent of the joint spot J on the roof side rail 10 increases, and the upper end portion of the center pillar 14 descends together with the roof side rail 10. In this manner, if the upper end portion of the center pillar 14 descends, the center pillar 14 is greatly deformed inward in the vehicle width direction.

In this respect, with the vehicle body structure 1 according to the present embodiment of the invention, the deformation guide portions 21 and 23 that induce deformation of the roof side rail 10 are provided. Therefore, the roof side rail 10 is twisted from the positions where the deformation guide portions 21 and 23 are formed. The deformation guide portions 21 and 23 are spaced apart from the joint spot J with the center pillar 14, so the roof side rail 10 is substantially entirely twisted.

Therefore, the amount of descent of the joint spot J on the roof side rail 10 is smaller than in the case where a twist occurs from a position close to the joint spot J with the center pillar 14. In consequence, the amount of descent of the upper end portion of the center pillar 14 is also small, and the amount of inward deformation of the center pillar 14 in the vehicle width direction is small. In this manner, with the vehicle body structure 1, a twist occurs from the position spaced apart from the joint spot J between the roof side rail 10 and the center pillar 14. Therefore, the center pillar 14 is restrained from being deformed inward in the vehicle width direction.

As described above, with the vehicle body structure 1 according to the present embodiment of the invention, when a load is input from the lateral portion of the vehicle, the roof side rail 10 is guided in such a manner as to be deformed along the direction that extends in the direction of the virtual axis B that is inclined with respect to the direction of the virtual axis A of the roof side rail 10 in a lateral view, by the deformation guide portions 21 and 23. The cross-section of the roof side rail 10 along the direction of the virtual axis B is larger in area than the cross-section of the roof side rail 10 along the direction of the virtual axis A. Accordingly, by providing guidance such that the roof side rail 10 is deformed along the direction of the virtual axis B, the point from which the roof side rail 10 is twisted at the time of a lateral collision can be set to a position corresponding to a large cross-section and a large yield strength. Therefore, the torsion reactive force generated in the roof side rail 10 can be increased. In consequence, according to this vehicle body structure 1, the performance against a collision from the lateral face of the vehicle can be enhanced.

Besides, with the vehicle body structure 1 according to the present embodiment of the invention, the roof side rail 10 is configured by combining the outer roof side rail 10A disposed on the outer side with respect to the vehicle and the inner roof side rail 10B disposed on the inner side with respect to the vehicle with each other in a face-to-face manner. The deformation guide portion 23 is constituted by the hole that is formed on the virtual axis B of the outer roof side rail 10A. Accordingly, when a collision load is input from the lateral face of the vehicle, stress concentrates on the hole that is formed through the outer roof side rail 10A on the virtual axis B, so initial deformation in the direction of the virtual axis B can be induced. Therefore, guidance can be provided such that the roof side rail is deformed along the direction of the virtual axis B.

Besides, with the vehicle body structure 1 according to the present embodiment of the invention, the hole is rectangular, and one diagonal line of the hole extends along the direction of the virtual axis B. Accordingly, stress concentrates on the diagonal line of the rectangular hole with a large opening width, so guidance can be provided such that the roof side rail is deformed along the direction of the virtual axis B.

Besides, with the vehicle body structure 1 according to the present embodiment of the invention, the notch portion 24 that extends along the direction of the virtual axis B is formed at the edge of the outer roof side rail 10A. Accordingly, stress concentrates at the notch portion 24, so a trigger for deformation of the roof side rail 10 in the direction of the virtual axis B can be created. If the hole is enlarged, the strength of the roof side rail 10 decreases. However, by providing the notch portion 24, guidance can be provided such that the roof side rail 10 is deformed along the direction of the virtual axis B without enlarging the hole.

Besides, the vehicle body structure 1 is further equipped with the front pillar 16 that extends in the vertical direction of the vehicle and is joined to the front end portion of the roof side rail 10, and the deformation guide portion 21 is provided on the front pillar 16 side with respect to the intermediate position C1 between the center pillar 14 and the front pillar 16. Therefore, the roof side rail 10 is twisted from the deformation guide portion 21 that is provided on the front pillar 16 side with respect to the intermediate position C1 between the center pillar 14 and the front pillar 16. Therefore, the roof side rail 10 is twisted from the position spaced apart from the joint spot J with the center pillar 14 on the roof side rail 10, so the joint spot J with the center pillar 14 on the roof side rail 10 is prevented from shifting downward. In consequence, according to the vehicle body structure 1, the center pillar 14 can be restrained from being deformed, and the performance against a collision from the lateral face of the vehicle can be enhanced.

Besides, the vehicle body structure 1 is further equipped with the rear pillar 18 that extends in the vertical direction of the vehicle and is joined to the rear end portion of the roof side rail 10, and the deformation guide portion 23 is provided on the rear pillar 18 side with respect to the intermediate position C2 between the center pillar 14 and the rear pillar 18. Therefore, the roof side rail 10 is twisted from the deformation guide portion 23 that is provided on the rear pillar 18 side with respect to the intermediate position C2 between the center pillar 14 and the rear pillar 18. Therefore, the roof side rail 10 is twisted from the position spaced apart from the joint spot J with the center pillar 14 on the roof side rail 10, so the joint spot J with the center pillar 14 on the roof side rail 10 is prevented from shifting downward. In consequence, according to this vehicle body structure 1, the center pillar 14 can be restrained from being deformed, and the performance against a collision from the lateral face of the vehicle can be enhanced.

While the embodiment of the invention has been described above, the invention is not limited to the aforementioned embodiment thereof. For example, in the aforementioned embodiment of the invention, the deformation guide portions 21 and 23 are provided at the front and rear portions of the roof side rail 10 respectively. However, at least one of the deformation guide portions 21 and 23 may be provided.

Besides, in the aforementioned embodiment of the invention, the rectangular holes are formed through the outer roof side rail 10A as the deformation guide portions 21 and 23 respectively. However, the holes are not absolutely required to be rectangular, and may assume any shape. For example, as the deformation guide portion 21, an elliptical hole having a major axis in the direction of the virtual axis B or a polygonal hole having a diagonal line in the direction of the virtual axis B may be formed.

### DESCRIPTION OF REFERENCE SYMBOLS

1 . . . VEHICLE BODY STRUCTURE
10 . . . ROOF SIDE RAIL
10A . . . OUTER ROOF SIDE RAIL
10B . . . INNER ROOF SIDE RAIL
12 . . . ROCKER
14 . . . CENTER PILLAR
16 . . . FRONT PILLAR
18 . . . REAR PILLAR
21, 23 . . . DEFORMATION GUIDE PORTION
B . . . VIRTUAL AXIS
J . . . JOINT SPOT

1. A vehicle body structure comprising:
a roof side rail that is arranged at a lateral position on an upper side of a vehicle and extends in a longitudinal direction of the vehicle; and
a center pillar that extends in a vertical direction of the vehicle and has an upper end portion that is joined to a non-end position of the roof side rail in an extension direction of the roof side rail, wherein
a deformation guide portion that is configured to guide the roof side rail to deform along a direction of a virtual axis that extends in a direction inclined with respect to a direction perpendicular to the extension direction of the roof side rail in a lateral view when a load is input from a lateral portion of the vehicle is formed on the roof side rail, and
the deformation guide portion is constituted by a hole that is formed through the roof side rail on the virtual axis.

2. The vehicle body structure according to claim 1, wherein
the roof side rail is constituted by an outer roof side rail and an inner roof side rail,
the outer roof side rail is disposed on an outer side of the vehicle
the inner roof side rail is disposed on an inner side of the vehicle,
the outer roof side rail and the inner roof side rail are combined with each other and are disposed face-to-face with each other, and
the hole is formed through the outer roof side rail on the virtual axis.

3. The vehicle body structure according to claim 2, wherein
the hole is rectangular, and
one diagonal line of the hole extends along the direction of the virtual axis.

4. The vehicle body structure according to claim 2, wherein
a notch portion that extends along the direction of the virtual axis is formed at an edge of the outer roof side rail.

5. The vehicle body structure according to claim 1, further comprising:
a front pillar that extends in the vertical direction of the vehicle and is joined to a front end portion of the roof side rail, wherein
the deformation guide portion is provided on a front pillar side with respect to an intermediate position between the center pillar and the front pillar, and
the direction of the virtual axis is a direction that is inclined upward toward a front side of the vehicle with respect to the direction perpendicular to the extension direction of the roof side rail, in the lateral view.

6. The vehicle body structure according to claim 1, further comprising
a rear pillar that extends in the vertical direction of the vehicle and is joined to a rear end portion of the roof side rail, wherein
the deformation guide portion is provided on a rear pillar side with respect to an intermediate position between the center pillar and the rear pillar, and
the direction of the virtual axis is a direction that is inclined upward toward a rear side of the vehicle with respect to the direction perpendicular to the extension direction of the roof side rail, in the lateral view.
